(19) United States
(12) Patent Application Publication
(10) Pub. No.: US 2017/0240313 A1
(43) Pub. Date: Aug. 24, 2017

(54) Carrier For Containers

(71) Applicant: Graphic Packaging International, Inc., Atlanta, GA (US)

(72) Inventor: Kirsten L. Brand, Hackettstown, NJ (US)

(21) Appl. No.: 15/591,502

(22) Filed: May 10, 2017

Related U.S. Application Data
(62) Division of application No. 14/712,299, filed on May 14, 2015.
Application No. 14/712,299 is a division of application No. 13/025,582, filed on Feb. 11, 2011, now Pat. No. 9,061,810.
(60) Provisional application No. 61/338,002, filed on Feb. 12, 2010.

(51) Int. Cl. B65D 5/44; B65D 71/58; B65D 5/48; B65D 5/42; B65D 5/20; B65D 5/468

(52) U.S. Cl. CPC B65D 5/443; B65D 5/20; B65D 5/4608; B65D 5/48002; B65D 5/4266; B65D 71/0022; B31B 3/26; B31B 1/86; B31B 1/26; B65D 2571/00141; B65D 2571/0037; B65D 2571/00487; B65D 2571/00524; B65D 2571/0066; B65D 2571/00722; B31B 2203/10; B31B 2201/26; B31B 2201/909; B31B 2241/001

(57) ABSTRACT

A carrier for holding a plurality of containers. The carrier comprises a plurality of panels that extend at least partially around an interior of the carrier. The plurality of panels comprises at least one bottom panel, a front panel, a back panel, and at least two side panels. The interior of the carrier is divided into a front portion and a back portion. The carrier comprises a reinforced handle comprising a handle panel, a handle reinforcement panel at least partially overlapping the handle panel, and a handle reinforcement flap at least partially in face-to-face contact with the handle reinforcement panel.

### CROSS-REFERENCE TO RELATED APPLICATIONS

This application is a divisional of U.S. patent application Ser. No. 14/712,299, filed May 14, 2015, which is a divisional of U.S. patent application Ser. No. 13/025,582, filed Feb. 11, 2011, which application claims the benefit of U.S. Provisional Patent Application No. 61/338,002, filed Feb. 12, 2010.

### INCORPORATION BY REFERENCE

U.S. patent application Ser. No. 14/712,299, which was filed on May 14, 2015, U.S. patent application Ser. No. 13/025,582, which was filed on Feb. 11, 2011, and U.S. Provisional Patent Application No. 61/338,002, which was filed on Feb. 12, 2010, are hereby incorporated by reference for all purposes as if presented herein in their entirety.

### BACKGROUND OF THE DISCLOSURE

The present disclosure generally relates to carriers or cartons for holding and displaying containers. More specifically, the present disclosure relates to basket-style carriers.

### SUMMARY OF THE DISCLOSURE

In general, one aspect of the disclosure is directed to a carrier for holding a plurality of containers. The carrier comprises panels that extend at least partially around an interior of the carrier. The panels comprise at least one bottom panel, a front panel, a back panel, and at least two side panels. The interior of the carrier is divided into a front portion and a back portion. The carrier comprises a reinforced handle comprising a handle panel, a handle reinforcement panel at least partially overlapping the handle panel, and a handle reinforcement flap at least partially in face-to-face contact with the handle reinforcement panel.

In another aspect, the disclosure is generally directed to a blank for forming a carrier for holding a plurality of containers. The blank comprises a plurality of panels comprising at least one bottom panel, a front panel, a back panel, and at least two side panels. The blank also comprises features for forming a reinforced handle comprising a handle panel, a handle reinforcement panel, and a handle reinforcement flap foldably connected to the handle reinforcement panel along a first longitudinal fold line. The handle panel and the handle reinforcement panel generally extending along a centerline of the blank.

In another aspect, the disclosure is generally directed to a method of forming a carrier for containing a plurality of containers. The method comprises obtaining a blank comprising a plurality of panels comprising at least one bottom panel, a front panel, a back panel, and at least two side panels. The blank further includes a handle panel, a handle reinforcement panel, and a handle reinforcement flap. The handle reinforcement flap is foldably connected to the handle reinforcement panel along a first longitudinal fold line. The method further comprises folding the handle reinforcement flap along the first longitudinal fold line so that the handle reinforcement flap is at least partially in face-to-face contact with the handle reinforcement panel, and folding the plurality of panels to selectively overlap respective panels of the plurality of panels. The folding the plurality of panels comprises at least partially overlapping the handle reinforcement panel with the handle panel. The method further comprises forming a reinforced handle by folding the handle panel, the handle reinforcement panel, and the handle reinforcement flap along a longitudinal centerline, and forming an interior of the carrier by further respectively folding the plurality of panels, the interior of the carrier being divided into a front portion and a back portion.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is an exterior plan view of a blank used to form a carrier according to a first embodiment of the disclosure.

FIGS. 2-4 are views showing folding of the blank of FIG. 1 to form the carrier according to the first embodiment.

FIGS. 5A-5C are perspective views of the assembled carrier according to the first embodiment.

FIG. 6 is an exterior plan view of a blank used to form a carrier according to a second embodiment of the disclosure.

FIG. 7 is a plan view of a reinforcement panel of the blank of FIG. 6 after folding a reinforcement flap according to the second embodiment.

FIG. 8 is an exterior plan view of a blank used to form a carrier according to a third embodiment of the disclosure.

FIG. 9 is a plan view of a reinforcement panel of the blank of FIG. 8 after folding two reinforcement flaps according to the third embodiment.

Corresponding parts are designated by corresponding reference numbers throughout the drawings.

### DETAILED DESCRIPTION OF THE EXEMPLARY EMBODIMENT

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, plastics such as PET, LDPE, LLDPE, HDPE, PP, PS, PVC, EVOH, and Nylon; and the like; aluminum and/or other metals; glass; or any combination thereof.

Carriers according to the present disclosure can accommodate containers of numerous different shapes. For the purpose of illustration and not for the purpose of limiting the scope of the disclosure, the following detailed description describes beverage containers (e.g., glass bottles or plastic containers) at least partially disposed within the carrier embodiments. In this specification, the terms “lower,” “bottom,” “upper,” “top,” “front,” and “back” indicate orientations determined in relation to fully erected carriers.

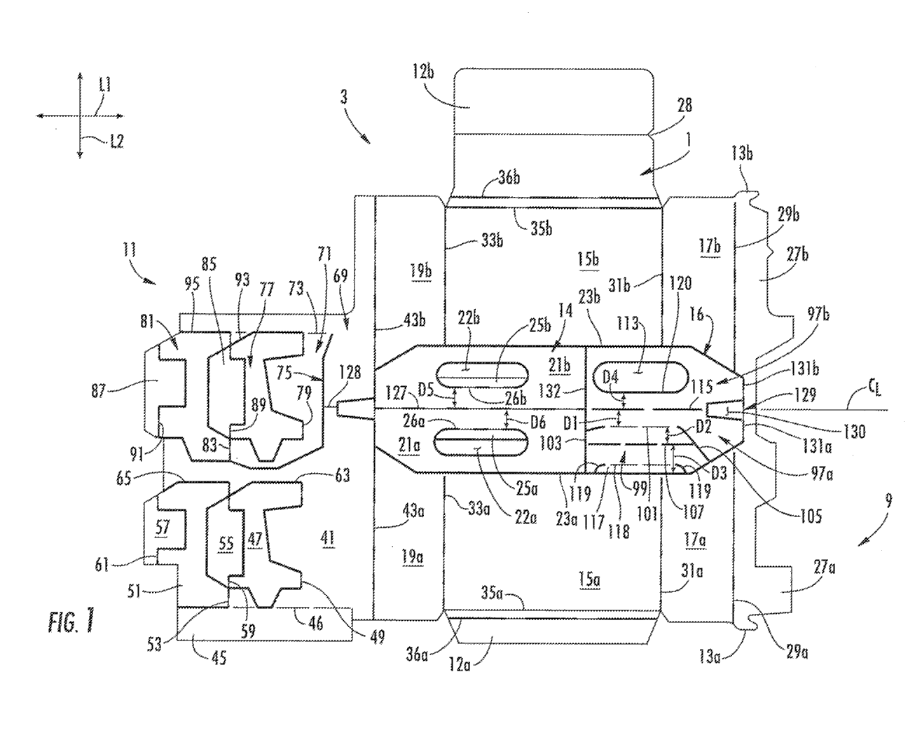

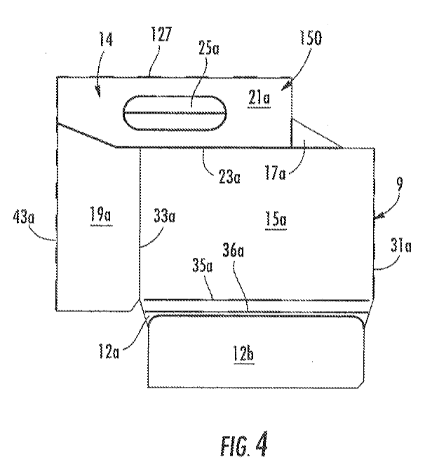

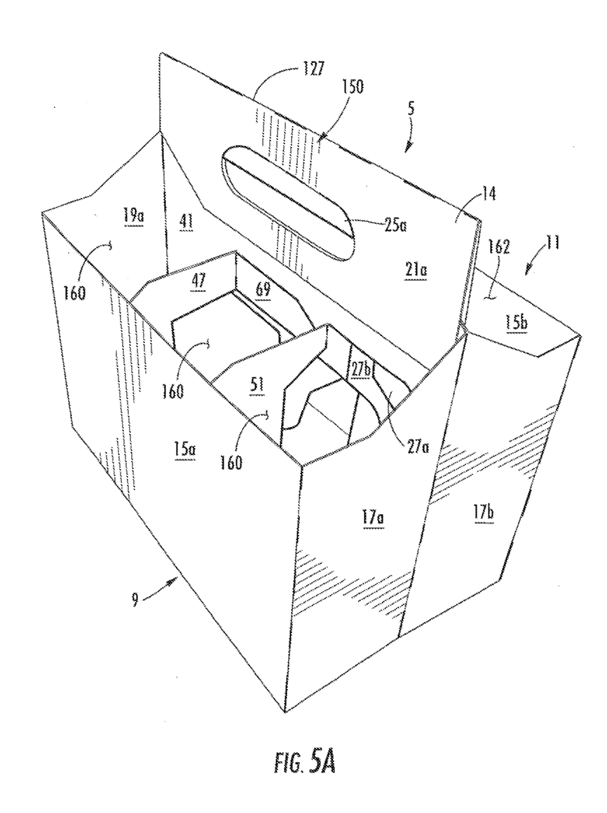

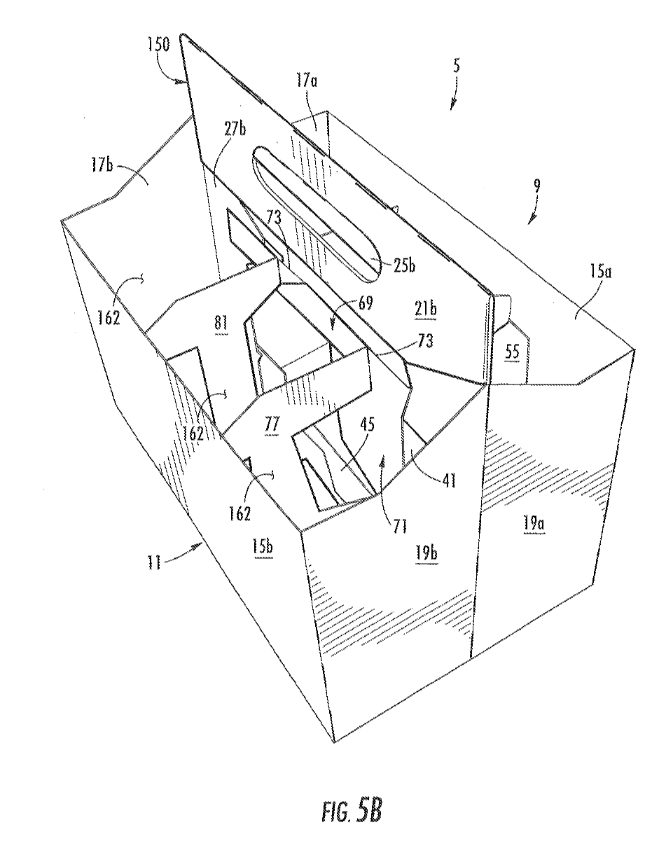

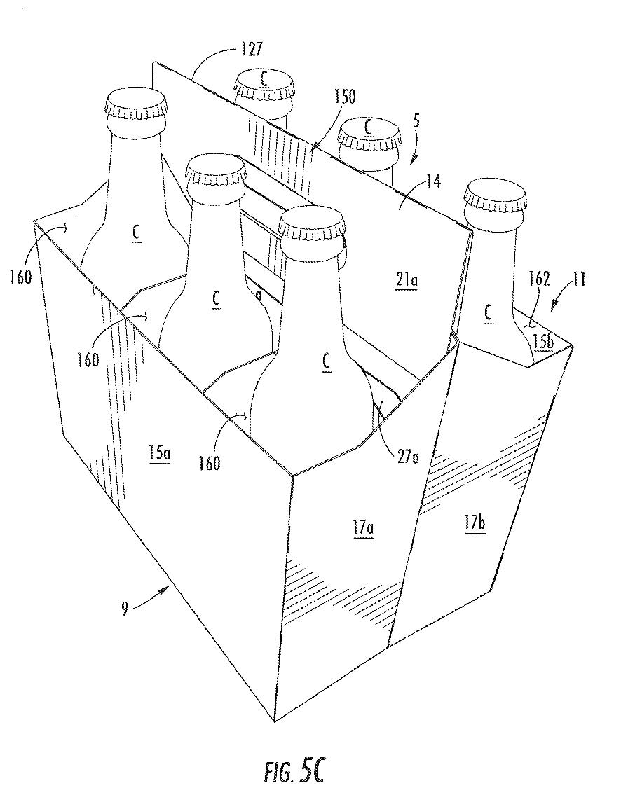

FIG. 1 is a plan view of an exterior side 1 of the blank 3 used to form a package or basket-style carrier 5 (FIGS. 5A, 5B, and 5C), in accordance with a first embodiment of the present disclosure. As shown in FIGS. 5A, 5B, and 5C, the carrier 5 is sized to contain six containers C, three containers being contained in a front portion of the carrier (FIG. 5A) and three containers being contained in a back portion of the carrier (FIG. 5B). The carrier can be sized and shaped to hold more or less than six containers C without departing from the disclosure. In the illustrated embodiment, the carrier 5 includes a reinforced handle 150 (FIGS. 4, 5A, and 5B), which can include a handle panel 14 and a handle reinforcement panel 16.

The carrier blank 3 has a longitudinal axis L1 and a lateral or transverse axis L2. The carrier blank 3 has a front portion 9, a back portion 11, a bottom panel 12b foldably connected to the back portion, and a bottom attachment flap 12a foldably connected to the front portion. In the illustrated embodiment, the front portion 9 and back portion 11 are for being folded about a longitudinal centerline CL (FIG. 1) when the carrier blank 3 is formed into the carrier 5. As discussed in more detail below, the carrier blank 3 is formed into the carrier 5 by folding the carrier blank about the centerline CL so that the front portion 9 and the back portion 11 are generally overlapped.

In the illustrated embodiment, the front portion 9, comprises a front panel 15a foldably connected to a first side panel 17a and a second side panel 19a. A front central flap 27a is foldably connected to the first side panel 17a at a lateral fold line 29a. Lateral fold lines 31a, 33a, foldably connect the respective first and second side panel 17a, 19a to the front panel 15a. Two longitudinal folds line 35a, 36a connect the bottom panel attachment flap 12a to the front panel 15a.

In the illustrated embodiment, the features of the back portion 11 of the blank 3 include a back panel 15b, a first side panel 17b, and a second side panel 19b, that are generally a mirror-image of the corresponding panel or flap of the front portion 9. A back central flap 27b is also similarly configured to the front central flap 27a, and a longitudinal fold line 129 foldably connects the front central flap 27a to the back central flap 27b. Corresponding components (e.g., panels, flaps, fold lines, cuts, etc.) have been designated by corresponding reference numbers that differ by the “a” or “b” suffix, with the “a” components corresponding to the front portion 9 and the “b” components corresponding to the back portion 11 of the blank 3.

In one embodiment, the front portion 9 includes a front central panel 41 foldably connected to the second side panel 19a at a lateral fold line 43a. The central panel 41 includes a central bottom flap 45 foldably connected to the front central panel 41 along a longitudinal fold line 46. A first divider flap 47 is foldably connected to the front central panel 41 at a lateral fold line 49. A second divider flap 51 is foldably connected to the front central panel 41 at a lateral fold line 53. The first divider flap 47 includes a first attachment flap 55, and the second divider flap 51 includes a second attachment flap 57. The first attachment flap 55 is foldably connected to the first divider flap at a lateral fold line 59, and the second attachment flap 57 is foldably connected to the second divider flap at a lateral fold line 61. The first divider flap 47 is at least partially defined by a tear or cut line 63 and the lateral fold line 49. The second divider flap 51 is at least partially defined by the lateral fold line 53 and a tear or cut line 65 that extends from a lateral edge of the blank 3 to the fold line 53. The divider flaps 47, 51 could be otherwise shaped, arranged, and/or configured without departing from the disclosure.

The back portion 11 includes a back central panel 69 foldably connected to the second side panel 19b at a lateral fold line 43b. The back central panel 69 can include a divider panel 71 foldably connected to the back central panel 69 along a longitudinal fold line 73 and separable from the front and back central panels 41, 69 along a tear or cut line 75. A first divider flap 77 is foldably connected to the divider panel 71 at a lateral fold line 79, and a second divider flap 81 is foldably connected to the divider panel 71 at a lateral fold line 83. Each divider flap 77, 81 includes a respective attachment flap 85, 87 foldably connected to a respective divider flap at a lateral fold line 89, 91. The first divider flap 77 is at least partially defined by a tear or cut line 93 and the lateral fold line 79. The second divider flap 81 is at least partially defined by the cut line 75, the lateral fold line 83, and a tear or cut line 95 that extends from a lateral edge of the blank 3 to the fold line 83. In the illustrated embodiment, the front central panel 41 is foldably connected to the back central panel 69 along a line of weakening 128, which can include a fold line and an opening. The front portion 9, the back portion 11, the central flaps 27a, 27b, the central panels 41, 69, and/or the divider flaps 47, 51, 77, 81 could be alternatively shaped, arranged, and/or configured, or could be omitted, without departing from the present disclosure.

In the illustrated embodiment, the handle panel 14 and the handle reinforcement panel 16 are generally disposed between the front and back portions 9, 11. The handle panel 14 includes a front handle portion 21a and a back handle portion 21b foldably connected to the front handle portion 21a along a longitudinal fold line or other line of weakening 127. The front handle portion 21a is foldably connected to the front central panel 41 along the lateral fold line 43a, and the back handle portion 21b is foldably connected to the back central panel 69 along the lateral fold line 43b. The front handle portion 21a can include a front handle opening 22a and a front handle cushion flap 25a foldably connected to the front handle portion along a longitudinal fold line 26a adjacent the front handle opening 22a. The back handle portion 21b can include a back handle opening 22b and a back handle cushion flap 25b foldably connected to the back handle portion along a longitudinal fold line 26b adjacent the back handle opening 22b. The handle panel 14 could be otherwise shaped, arranged, and/or configured, or could be omitted, without departing from the disclosure.

The handle reinforcement panel 16 can include a front handle reinforcement portion 97a and a back handle reinforcement portion 97b foldably connected to the front handle reinforcement portion 97a along a longitudinal fold line or other line of weakening 115. An opening 130 can be included between the handle reinforcement portions 97a, 97b. The front handle reinforcement portion 97a is foldably connected to the front central flap 27a along a lateral fold line 131a, and the back handle reinforcement portion 97b is foldably connected to the back central flap 27b along a lateral fold line 131b. In the illustrated embodiment, the lateral fold lines 131a, 131b are spaced apart or offset from the lateral fold lines 29a, 29b connecting the respective front and back central flaps 27a, 27b to the respective first side panels 17a, 17b. Alternatively, the lateral fold lines 131a, 131b can be collinear with the lateral fold lines 29a, 29b. In the illustrated embodiment, the front handle reinforcement portion 97a includes a handle reinforcement flap 99, and the back handle reinforcement portion 97b includes an elongate handle opening 113.

The handle reinforcement flap 99 can be foldably connected to the front handle reinforcement portion 97a by a longitudinal fold line 101. In the first embodiment, the reinforcement flap 99 is separated from the front handle reinforcement portion 97a by respective cuts 103, 105. The handle reinforcement flap 99 includes a fold line or other line of weakening 107 and a central handle cushion flap 117. The central handle cushion flap 117 can be foldably connected to the handle reinforcement flap 99 along a longitudinal fold line 118 and can be separated from handle reinforcement flap at cut or tear lines 119. The handle reinforcement panel 16 could be otherwise shaped, arranged, and/or configured, or could be omitted, without departing from the disclosure. For example, the fold lines 107, 115 could be other forms of weakening, such as one including a series of openings and fold lines.

In the illustrated embodiment, the line of weakening 128 and the longitudinal fold lines 115, 127, 129 are generally aligned with the longitudinal centerline CL of the blank 3. The front handle portion 21a is adjacent the front panel 15a and the second side panel 19a, and the front handle reinforcement portion 97a is adjacent the front panel 15a and the first side panel 17a. The front handle portion 21a and the front handle reinforcement portion 97a are separated from the front panel 15a and the respective second side panel 19a and first side panel 17a by a cut 23a. Similarly, the back handle portion 21b and the back handle reinforcement portion 97b are separated from the back panel 15b and the respective second side panel 19b and first side panel 17b by a cut 23b. In the illustrated embodiment, the front and back handle reinforcement portions 97a, 97b are separable from the respective handle portions 21a, 21b along a tear or cut line 132. Alternatively, the handle reinforcement portions can be spaced apart from the handle portions. Further, the handle portions, the handle reinforcement portions, and the handle reinforcement flap could be otherwise shaped, arranged, and/or configured, or could be omitted, without departing from the disclosure.

In the illustrated embodiment, the longitudinal fold line 101 can be spaced apart from the longitudinal fold line 115 a distance D1, and the longitudinal fold line 107 can be spaced apart from the longitudinal fold line 101 a distance D2. The distance D1 can be substantially equal to the distance D2 so that the fold line 107 overlays the fold line 115 when the handle reinforcement flap 99 is folded along the longitudinal fold line 101. Additionally, the longitudinal fold line 107 can be spaced apart from the cut 23a a distance D3, and the upper edge of the handle opening 113 can be spaced apart from the longitudinal fold line 115 a distance D4. In the illustrated embodiment, the distance D3 is greater than the distance D4 so that a portion (e.g., the central handle cushion flap 117) of the handle reinforcement flap 99 overlays the handle opening 113 when the handle reinforcement flap 99 is folded along the longitudinal fold line 101. In an alternative embodiment, distance D4 can be generally equal to distance D3. Additionally, in one embodiment, the distance D4 can be substantially equal to the distance D1.

The fold line 26b, extending along the upper edge of the back handle opening 22b, can be spaced apart from the longitudinal fold line 127 a distance D5 that is generally equal to or greater than the distance D4 between the upper edge of the handle opening 113 and the longitudinal fold line 115 so that the back handle opening 22b is aligned with the handle opening 113 when the reinforced handle 150 is formed. The handle opening 113 can be larger than the back handle opening 22b so that substantially all of the back handle opening 22b positioned within the handle opening 113 regardless of variations in alignment of the handle panel 14 and the handle reinforcement panel 16 when the reinforced handle 150 is formed. Additionally, the fold line 26a, extending along the upper edge of the front handle opening 22a, can be spaced apart from the longitudinal fold line 127 a distance D6 that is generally equal to or greater than the distance D1 between the longitudinal fold lines 101, 115 so that substantially all of the front handle opening 22a is positioned within a recess in the front handle reinforcement portion 97a formed when the handle reinforcement panel 99 is folded along the longitudinal fold line 101. In one embodiment, the distance D5 can be substantially equal to the distance D6. The distances can be alternatively configured without departing from the present disclosure.

Any of the panels, flaps, fold lines, cuts, or other features could be otherwise shaped, arranged, and/or omitted from the blank 3 without departing from the disclosure. The blank 3 could be sized and/or shaped to accommodate more or less than six containers C without departing from this disclosure.

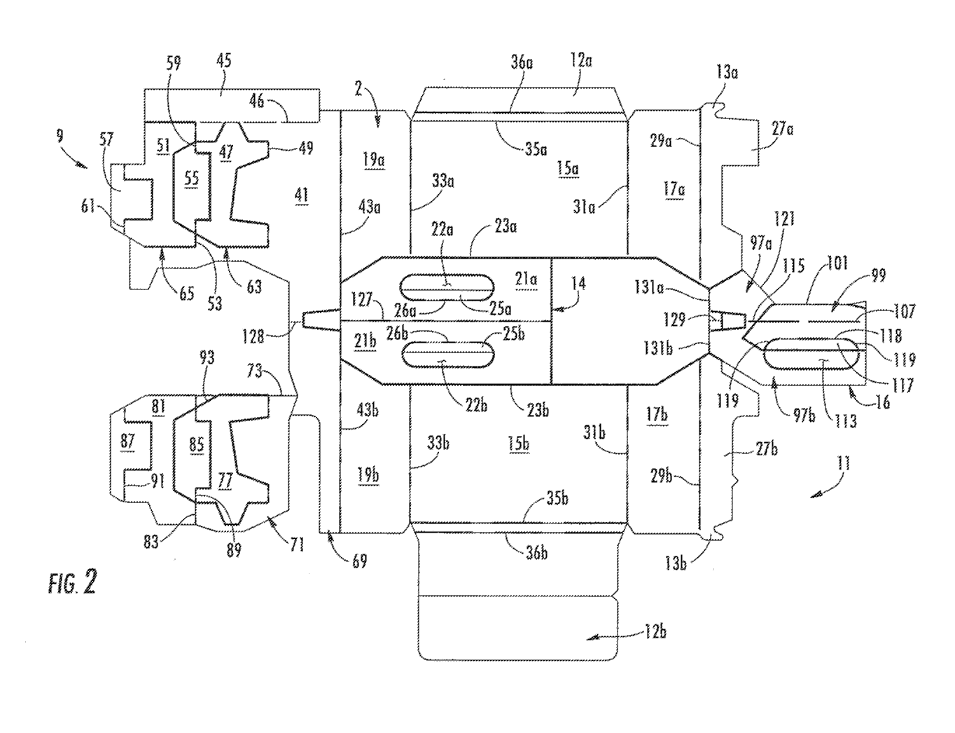

With reference to FIGS. 2-4, in one exemplary method of erection, the carrier 5 can be erected from the blank 3 by positioning the panels 15a, 15b, 17a, 17b, 19a, 19b, and the dividers 47, 51, 87, 91 relative to each other to form the front portion 9 of the carrier and the back portion 11 of the carrier. Particularly, FIG. 2 generally shows an interior surface 2 of the blank 3 after exemplary first folds of the blank, including folding the divider panel 71 along the longitudinal fold line 73 so that at least a portion of the divider panel is in face-to-face contact with the interior surface of the lower portion of the back central panel 69. The handle reinforcement panel 16 also can be folded along lateral fold lines 131a, 131b so that at least a portion of each of the front and back handle reinforcement portions 97a, 97b is in face-to-face contact with a portion of the interior surface of the respective front and back central flaps 27a, 27b. The front and back handle reinforcement portions 97a, 97b can be glued to the front and back central flaps 27a, 27b. The handle reinforcement flap 99 can be folded along the longitudinal fold line 101 to be in at least partially face-to-face contact with the exterior surface of the handle reinforcement panel 16. Particularly, the fold line 107 is generally aligned with and overlays the fold line 115 so that respective portions of the reinforcement flap 99 are in contact with a portion of the front handle reinforcement portion 97a and a portion of the back handle reinforcement portion 97b to form a two-ply combined handle reinforcement panel. As shown in FIG. 2, the central handle cushion flap 117 is disposed adjacent the handle opening 113 in the back handle reinforcement portion 97b, and the longitudinal fold line 118 is generally aligned with and overlays an upper edge 120 of the handle opening 113. An opening or recess 121 can be defined by the fold line 101 and the edges of the front handle reinforcement portion 97a formed by the cuts 103, 105 after folding the handle reinforcement flap 99. The handle reinforcement flap 99 can be glued to the front handle reinforcement portion 97a and/or the back handle reinforcement portion 97b.

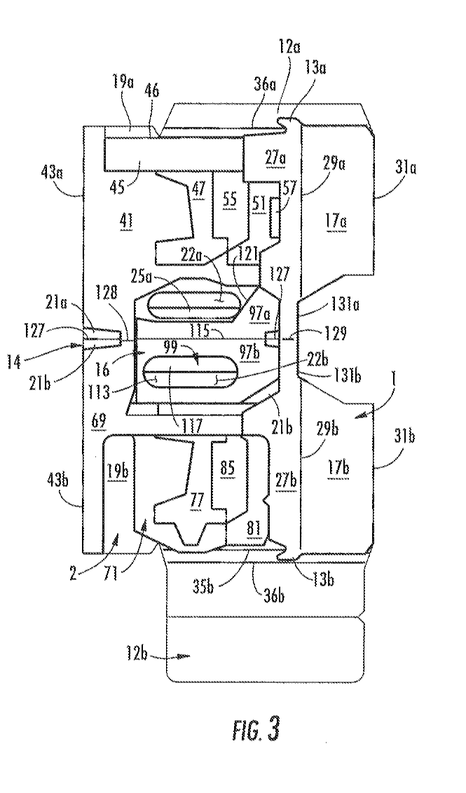

As shown in FIG. 3, the central bottom flap 45 can be folded along the longitudinal fold line 46 so that the central bottom flap is in face-to-face contact with the exterior surface 1 of the front central panel 41. The front and back central panels 41, 69 can be folded about respective fold lines 43a, 43b so that the central panels are generally in face-to-face relationship with portions of the respective handle portions 21a, 21b, the respective second side panels 19a, 19, and the respective front and back panels 15a, 15b. The line of weakening 128 is generally aligned with and overlays the longitudinal fold line 127 of the handle panel 14. Glue or other adhesive is selectively applied to the blank 3 to adhesively connect the attachment flaps 55, 57 to the front panel 15a and to adhesively connect the attachment flaps 85, 87 to the back panel 15b. Additionally, in one particular embodiment, the portions of the central panels 41, 69 in face-to-face contact with the respective front and back handle portions 21a, 21b can be adhered or otherwise secured to the handle portions.

In one embodiment, the first side panels 17a, 17b can be folded about respective fold lines 31a, 31b so that the first side panels 17a, 17b and central flaps 27a, 27b are generally in face-to-face contact with portions of the respective front and back central panels 41, 69. Portions of the front central flap 27a can be selectively glued to portions of the front central panel 41 and the central bottom flap 45, and portions of the back central flap 27b can be selectively glued to portions of the back central panel 69. The handle reinforcement panel 16 is at least partially in face-to-face contact with the handle panel 14, with the handle reinforcement flap 99 between portions of the front and back handle reinforcement portions 97a, 97b and the respective front and back handle portions 21a, 21b. Portions of the front and back reinforcement panels 97a, 97b also can be in face-to-face contact with portions of the front and back handle portions 21a, 21b. The front and back handle reinforcement portions 97a, 97b and the handle reinforcement flap 99 can be glued to the front and back handle portions 21a, 21b to at least partially secure the handle reinforcement panel 16 to the handle panel 14. The handle opening 113 is generally aligned with the back handle opening 22b so that the central handle cushion flap 117 is generally aligned with the back handle cushion flap 25b with the fold line 118 generally aligned with the upper edge of the back handle opening 22b (e.g., the fold line 26b). In the illustrated embodiment, the edge of the handle reinforcement panel 16 formed by the longitudinal fold line 101 is generally aligned with and overlays the fold line 26a connecting the front handle cushion flap 25a to the front handle portion 21a at an upper edge of the front handle opening 22a so that at least a portion of the front handle opening 22a is proximate the recess 121 of the front handle reinforcement portion 97a. The longitudinal fold lines 107, 115, 129 and the line of weakening 128 overlay the longitudinal fold line 127, and the fold lines 107, 115, 127, 129 and the line of weakening 128 remain generally aligned with the centerline CL.

In one embodiment, the partially assembled blank 3 of FIG. 3 is folded about the longitudinal centerline CL (i.e., the longitudinal fold lines 107, 115, 127, 129 and the line of weakening 128) so that the front portion 9 generally overlaps the back portion 11 (FIG. 4). Portions of the front central panel 41 and the front central flap 27a can be selectively glued to portions of the respective back central panel 69 and back central flap 27b to generally form a central wall between the front portion 9 and the back portion 11. The handle panel 14, the handle reinforcement panel 16, and the handle reinforcement flap 99 combine to form the six-ply reinforced handle 150 with the front handle opening 22a being generally aligned with the back handle opening 22b and the handle opening 113 of the back handle reinforcement portion 97b. The central handle cushion flap 117 can also be aligned with and disposed between the front and back handle cushion flaps 25a, 25b. The six-ply reinforced handle 150 comprises six plies or layers of material at least between the upper edges of the handle openings 22a, 22b to the longitudinal fold line 127. The six plies can include the folded over reinforcement flap 99 (two layers comprising a respective portion of the flap on either side of the fold line 107), the front handle reinforcement portion 97a, the back handle reinforcement portion 97b, the front handle portion 21a, and the back handle portion 21b. The reinforced handle 150 of the carrier 5 could be otherwise shaped, arranged, and/or configured without departing from the disclosure. The bottom panel 12b can be folded along a fold line and attached to the bottom panel attachment flap 12a by glue so that the partially assembled blank 3 has the configuration shown in FIG. 4.

The blank 3 can be further assembled into the carrier 5, as shown in FIGS. 5A and 5B, by positioning the first side panels 17a, 17b and second side panels 19a, 19b to be in a generally spaced-apart, parallel planar relationship, and positioning the front panel 15a and back panel 15b to be in a generally spaced-apart, parallel planar relationship. Such movement of the side panels 17a, 17b, 19a, 19b and front and back panels 15a, 15b, causes the divider flaps 47, 51 in the front portion 9 of the carrier 5 to be positioned generally perpendicular to the central panel 41 and the front panel 15a, thereby dividing the front portion 9 into three container-receiving spaces 160 (FIG. 5A). Similarly, the back portion 11 of the carrier is divided into three container-receiving spaces 162 by the divider flaps 77, 81 (FIG. 5B). The separating of the front and back panels 15a, 15b further pulls the bottom panel 12b flat across the bottom of the carrier 5. Two hooks 13a, 13b disposed at the bottoms of the respective central flaps 27a, 27b can engage a notch 28 in the bottom panel 12b for supporting the bottom panel.

The reinforced handle 150 and the carrier 5 can be alternatively erected, formed, and/or arranged without departing from the present disclosure. For example, in an alternative embodiment, the handle reinforcement flap 99 is folded into face-to-face contact with the interior surface of the handle reinforcement panel 16 so that the handle reinforcement flap 99 is interior to both the handle panel 14 and the handle reinforcement panel 16.

In one embodiment, containers C, such as bottles, can be placed into the container-receiving spaces 160, 162 of the carrier 5 prior to folding the bottom panel 12b to close the bottom of the carrier 5. The bottoms of the containers are supported by the bottom panel 12b.

The exemplary carrier embodiment discussed above accommodates six containers C arranged in two rows, but the present disclosure is not limited to these numbers. As one example, additional containers may be accommodated by increasing the size of the blank 3 (e.g., in the longitudinal direction L1 in FIG. 1) and forming additional container-receiving spaces therein. Also, the carrier 5 could have less than six container-receiving spaces.

The panels, flaps, and dividers shown and described in conjunction with the blank 3 and the carrier 5 are included by way of example. The reinforced handle 150 can alternatively be associated with any basket-style carrier having any divider or panel configuration.

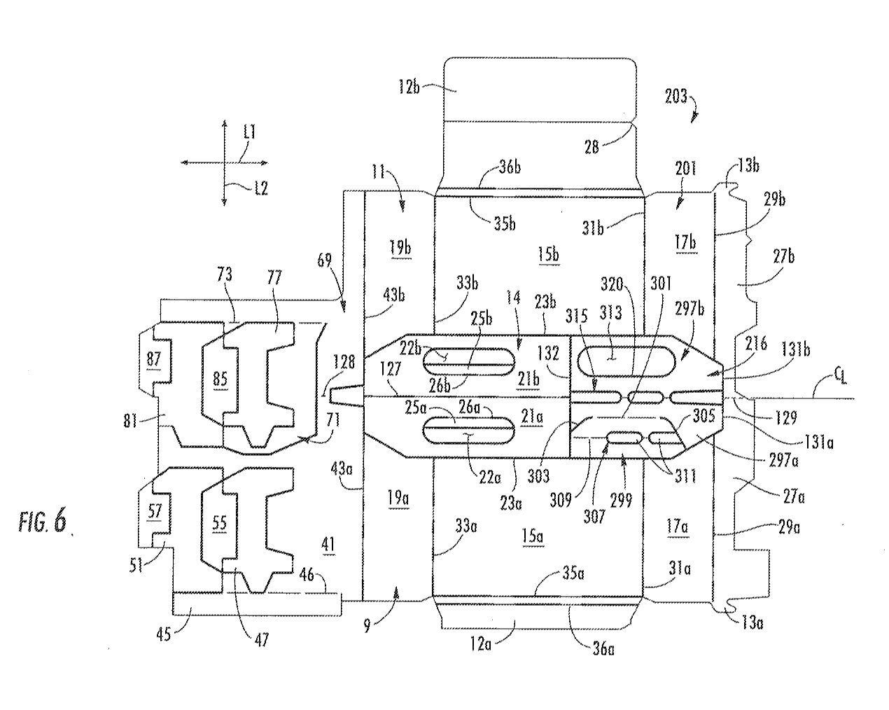

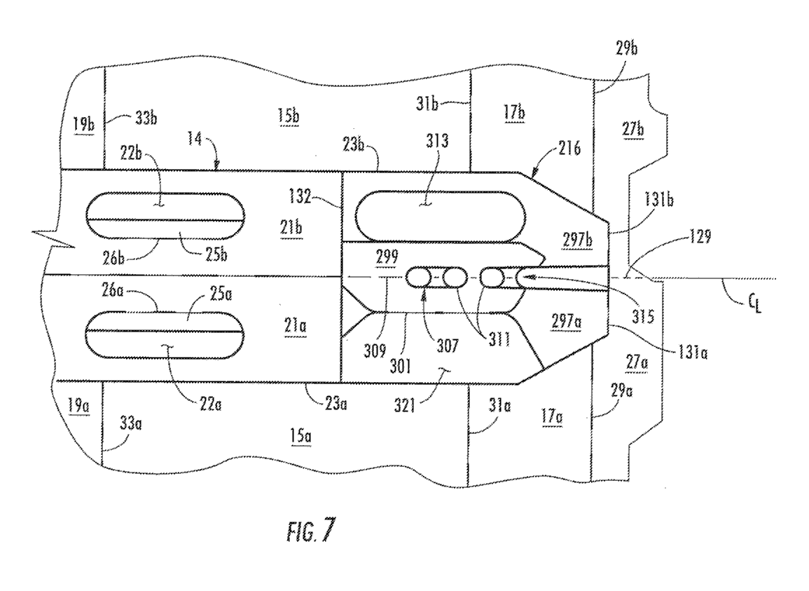

FIG. 6 is a plan view of an exterior surface 201 of a blank 203 for forming a carrier (not shown) according to a second embodiment of the disclosure. The second embodiment is generally similar to the first embodiment, except for variations noted and variations that will be apparent to one of ordinary skill in the art. Accordingly, similar or identical features of the embodiments have been given like or similar reference numbers. As shown in FIG. 6, the blank 203 includes a handle reinforcement panel 216 with a front handle reinforcement portion 297a, a back handle reinforcement portion 297b, and a handle reinforcement flap 299. The handle reinforcement flap 299 is shaped differently than the handle reinforcement flap of the first embodiment. In the embodiment of FIG. 2, the handle reinforcement flap 299 includes a line of weakening 307 that comprises a fold line 309 and two openings 311. Additionally, the line of weakening 315 between the front and back handle reinforcement portions comprises a series of openings and fold lines. The handle reinforcement flap 299 omits the central handle cushion flap 117 included in the first embodiment, and is sized and positioned so that an edge of the handle reinforcement flap is aligned with the upper edge 320 of the handle opening 313 when the handle reinforcement flap is folded along the longitudinal fold line 301 (FIG. 7). As shown in FIG. 7, the openings 311 can be offset in the longitudinal direction L1 from the openings of the line of weakening 315. Folding the handle reinforcement flap 299 into contact with the handle reinforcement panel 216 forms an opening or recess 321 in the front handle reinforcement portion 297a. The blank 203 could be otherwise shaped, arranged, and/or configured without departing from the disclosure.

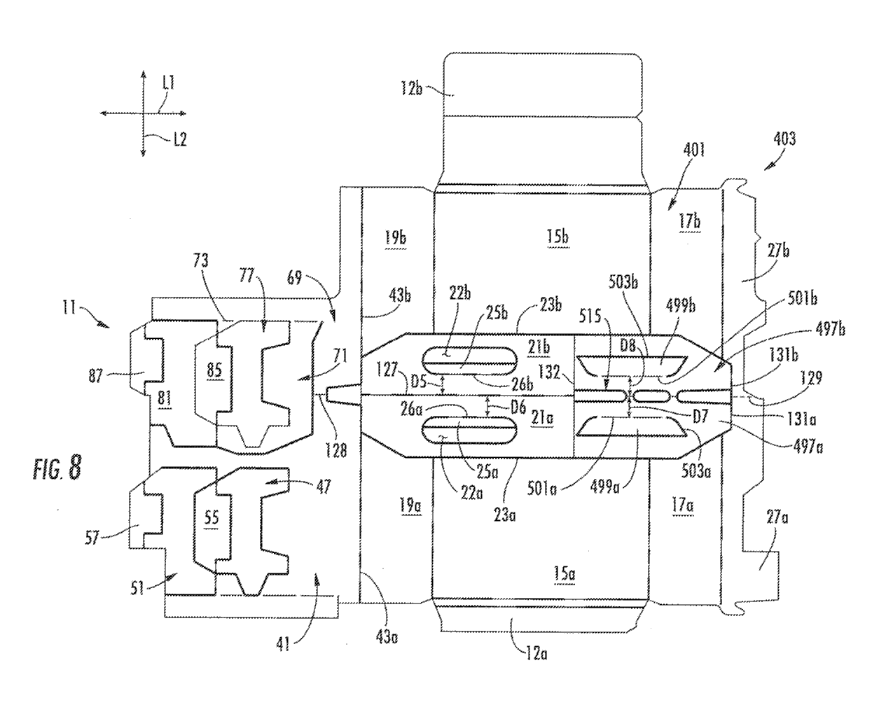

FIG. 8 is a plan view of an exterior surface 401 of a blank 403 for forming a carrier (not shown) according to a third embodiment of the disclosure. The third embodiment is generally similar to the first embodiment, except for variations noted and variations that will be apparent to one of ordinary skill in the art. Accordingly, similar or identical features of the embodiments have been given like or similar reference numbers. As shown in FIG. 8, the blank 403 has a front handle reinforcement portion 497a that comprises a front handle reinforcement flap 499a, and a back handle reinforcement portion 497b that comprises a back handle reinforcement flap 499b. The handle reinforcement flaps 499a, 499b are foldably connected to a respective handle reinforcement portions 497a, 497b at a respective longitudinal fold line 501a, 501b and are separable from the respective handle reinforcement portions 497a, 497b along respective tear lines or cuts 503a, 503b. As illustrated in FIG. 8, the longitudinal fold line 501a is spaced apart from a fold line portion of the line of weakening 515 a distance D7, which is generally equal to the distance D6 between longitudinal fold lines 26a, 127. Similarly, the longitudinal fold line 501b is spaced apart from the fold line portion of the line of weakening 515 a distance D8, which is generally equal to the distance D5 between longitudinal fold lines 26b, 127. Alternatively, the distances D7, D8 can be different than the respective distances D6, D5. In the third embodiment, the six-ply handle comprises six plies or layers of material that include the folded over reinforcement flaps 499a, 499b, the front handle reinforcement portion 497a, the back handle reinforcement portion 497b, the front handle portion 21a, and the back handle portion 21b.

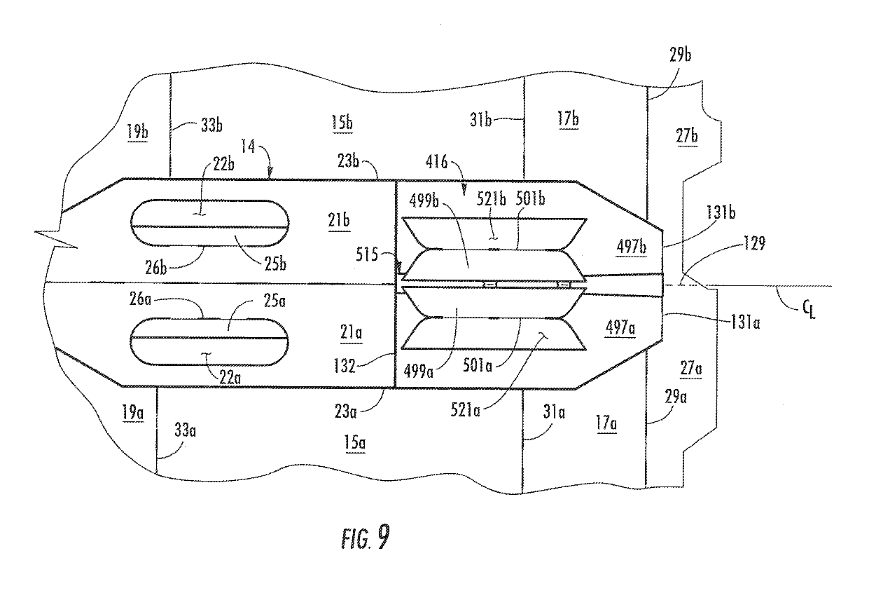

As shown in FIG. 9, the handle reinforcement flaps 499a, 499b can be folded along the respective longitudinal fold lines 501a, 501b. Accordingly, in FIG. 9, the front handle reinforcement flap 499a is in face-to-face contact with the front handle reinforcement portion 497a and overlays at least a portion of the line of weakening 515. Similarly, the back handle reinforcement flap 499b is in face-to-face contact with the back and overlays at least a portion of the line of weakening 515. Alternatively, the line of weakening 515 is a longitudinal fold line, and the respective edges of the front and back handle reinforcement flaps 499a, 499b are positioned adjacent the longitudinal fold line. The handle reinforcement flaps 499a, 499b can be folded into contact with the interior or exterior surface of the respective handle reinforcement portions 497a, 497b. When the reinforced handle is formed similarly to the formation of the handle 150 of the first embodiment, for example, the front handle reinforcement portion 497a overlaps the front handle portion 21a so that the fold line 501a is generally aligned with and at least partially overlays the fold line 26a, and the back handle reinforcement portion 497b overlaps the back handle portion 21b so that the fold line 501b is generally aligned with and at least partially overlays the fold line 26b. Accordingly, the handle cushion flaps 25a, 25b can pivot along the respective fold lines 26a, 26b into the handle openings 521a, 521b. The reinforced handle of the carrier could be otherwise shaped, arranged, and/or configured without departing from the disclosure.

In general, the blank may be constructed from paperboard having a caliper so that it is heavier and more rigid than ordinary paper. The blank can also be constructed of other materials, such as cardboard, or any other material having properties suitable for enabling the carrier or carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method for forming a carrier comprising:
obtaining a blank comprising a plurality of panels comprising at least one bottom panel, a front panel, a back panel, and at least two side panels, the blank further comprising a handle panel, a handle reinforcement panel, and a handle reinforcement flap, the handle reinforcement flap being foldably connected to the handle reinforcement panel along a first longitudinal fold line, wherein the handle reinforcement panel comprises a front handle reinforcement portion foldably connected to a back handle reinforcement portion along a second longitudinal fold line, and the first longitudinal fold line is laterally spaced apart from the second longitudinal fold line;
folding the handle reinforcement flap along the first longitudinal fold line so that the handle reinforcement flap is at least partially in face-to-face contact with the handle reinforcement panel;
folding the plurality of panels to selectively overlap respective panels of the plurality of panels, the folding the plurality of panels comprises at least partially overlapping the handle reinforcement panel with the handle panel;
forming a reinforced handle by folding the handle panel, the handle reinforcement panel, and the handle reinforcement flap along a longitudinal centerline; and
forming an interior of the carrier by further respectively folding the plurality of panels, the interior of the carrier being divided into a front portion and a back portion.

2. The method of claim 1, wherein:
the folding the handle reinforcement flap comprises folding the handle reinforcement flap to be at least partially in face-to-face contact with an exterior surface of the handle reinforcement panel; and
the at least partially overlapping the handle reinforcement panel with the handle panel comprises disposing the handle reinforcement flap at least partially in face-to-face contact with an interior surface of the handle panel.

3. The method of claim 1, wherein:
the handle panel comprises a front handle portion foldably connected to a back handle portion along a third longitudinal fold line; and
the overlapping the handle reinforcement panel with the handle panel comprises overlaying at least a portion of the third longitudinal fold line along at least a portion of the second longitudinal fold line.

4. A method for forming a carrier comprising:
obtaining a blank comprising a plurality of panels comprising at least one bottom panel, a front panel, a back panel, and at least two side panels, the blank further comprising a handle panel, a handle reinforcement panel, and a handle reinforcement flap, the handle reinforcement flap being foldably connected to the handle reinforcement panel along a first longitudinal fold line, wherein the handle reinforcement panel comprises a front handle reinforcement portion foldably connected to a back handle reinforcement portion along a second longitudinal fold line, the handle panel comprises a front handle portion foldably connected to a back handle portion along a third longitudinal fold line, and the handle reinforcement flap comprises a third longitudinal fold line;
folding the handle reinforcement flap along the first longitudinal fold line so that the handle reinforcement flap is at least partially in face-to-face contact with the handle reinforcement panel, wherein the folding the handle reinforcement flap comprises generally overlaying at least a portion of the third longitudinal fold line along at least a portion of the second longitudinal fold line of the handle reinforcement panel so that at least a portion of the handle reinforcement flap is in face-to-face contact with each of the front and back handle reinforcement portions;
folding the plurality of panels to selectively overlap respective panels of the plurality of panels, the folding the plurality of panels comprises at least partially overlapping the handle reinforcement panel with the handle panel, the overlapping the handle reinforcement panel with the handle panel comprises overlaying at least a portion of the third longitudinal fold line along at least a portion of the second longitudinal fold line;
forming a reinforced handle by folding the handle panel, the handle reinforcement panel, and the handle reinforcement flap along a longitudinal centerline; and
forming an interior of the carrier by further respectively folding the plurality of panels, the interior of the carrier being divided into a front portion and a back portion.

5. The method of claim 4, wherein:
the handle reinforcement flap is foldably connected to the front handle reinforcement portion along the first longitudinal fold line;
the back handle reinforcement portion comprises a handle opening; and
the folding the handle reinforcement flap comprises overlaying at least a portion of the handle reinforcement flap in face-to-face contact with the handle reinforcement panel at least between the second longitudinal fold line of the handle reinforcement panel and the handle opening in the back handle reinforcement portion.

6. The method of claim 5, wherein:
the handle opening of the back handle reinforcement portion comprises a first edge, the front handle portion comprises a front handle opening that comprises a second edge, and the back handle portion comprises a back handle opening that comprises a third edge;
the at least partially overlapping the handle reinforcement panel with the handle panel comprises at least partially overlaying the second edge along at least a portion of the first longitudinal fold line connecting the handle reinforcement flap to the handle reinforcement panel and at least partially overlaying the third edge along at least a portion of the first edge;
the folding the handle panel, the handle reinforcement panel, and the handle reinforcement flap along the longitudinal centerline comprises generally aligning the front handle opening, the back handle opening, and the handle opening of the back handle reinforcement portion.

7. The method of claim 3, wherein:
the handle reinforcement flap is a first handle reinforcement flap foldably connected to the front handle reinforcement portion along the first longitudinal fold line;
the reinforced handle further comprises a second handle reinforcement flap foldably connected to the back handle reinforcement portion along a fourth longitudinal fold line;
the folding the handle reinforcement flap comprises:
folding the first handle reinforcement flap into face-to-face contact with the front handle reinforcement portion extending between the first longitudinal fold line and the second longitudinal fold line; and
folding the second handle reinforcement flap into face-to-face contact with the back handle reinforcement portion extending between the fourth longitudinal fold line and the second longitudinal fold line.

8. The method of claim 1, wherein:
the blank further comprises at least one central panel and at least one central flap;
the at least two side panels comprise a first side panel and a second side panel;
the at least one central flap is foldably connected to the first side panel along a first transverse fold line, and the at least one central panel is foldably connected to the second side panel along a second transverse fold line;
at least a portion of the handle panel is foldably connected to the at least one central panel along a third transverse fold line, and at least a portion of the handle reinforcement panel is foldably connected to the at least one central flap along a fourth transverse fold line; and
the forming an interior of the carrier comprises positioning each of the at least one central panel and the at least one central flap at least partially between the front portion and the back portion of the carrier.
